(19) United States
(12) Patent Application Publication
(10) Pub. No.: US 2025/0216703 A1
(43) Pub. Date: Jul. 3, 2025

(54) ARM WRAP ADJUSTABILITY MECHANISMS

(71) Applicant: Apple Inc., Cupertino, CA (US)

(72) Inventors: Alison B. Shutzberg, San Francisco, CA (US); Christopher Patton, San Jose, CA (US); Deepeng Wang, San Jose, CA (US); Dominic P Cincione, San Francisco, CA (US)

(21) Appl. No.: 18/851,010

(22) PCT Filed: Apr. 4, 2023
(86) PCT No.: PCT/US2023/065328

§ 371 Date: Sep. 25, 2024

Related U.S. Application Data
(60) Provisional application No. 63/362,585, filed on Apr. 6, 2022.

(51) Int. Cl. G02C 11/00; G02B 27/01; G02C 5/14

(52) U.S. Cl. CPC G02C 11/10; G02B 27/0176; G02C 5/14; G02B 2027/0178

(57) ABSTRACT

A head-mountable device can include a viewing frame and a securement arm extending from the viewing frame. The securement arm can include a first portion having a first electronic component and a second portion rotatably connected to the first portion. The second portion can include a second electronic component. The securement arm can also include an electrical connector extending through the joint and electrically connecting the first electronic component and the second electronic component.

### CROSS-REFERENCE TO RELATED APPLICATION

This application is a national stage filing based off of PCT Application No. PCT/US2023065328, filed 4 Apr. 2023, and entitled “ARM WRAP ADJUSTABILITY MECHANISMS,” which claims priority to U.S. Provisional Patent Application No. 63/362,585, filed 6 Apr. 2022, and entitled “ARM WRAP ADJUSTABILITY MECHANISMS,” the entire disclosures of which are hereby incorporated by reference.

### FIELD

The described embodiments relate generally to electronic devices. More particularly, the present embodiments relate to head-mountable electronic devices.

### BACKGROUND

Recent advances in portable computing have enabled head-mountable devices that provide augmented and virtual reality experiences to users. Various component of these devices, such as display screens, viewing frames, securement arms, speakers, batteries, and other components, operate together to provide an immersive and comfortable experience. However, the anatomy of each user's head is unique. One user's head can be larger than another or one head can be a different shape. Other anatomical features, including relative positions of a user's nose, forehead, and ears, can vary widely between users as well. The anatomical variety of heads presents a challenge for head-mountable devices designed for comfort and reliability.

In some head-mountable devices, for example, securement arms that extend along, or make contact with, opposing sides of a user's head can be used to secure the device to the user's head. However, the dimensions, angles, shape, and other physical characteristics of the arms that may be sufficient to comfortably and reliably secure the device to one user's head may not be sufficient to comfortably and reliably secure the device to another user's head.

Additionally, head-mountable devices can be used in a variety of different settings and during a variety of different activities. These can range from lying down still in bed to mountain biking or hiking outdoors. Thus, even for a single user, the securement arms of a head-mountable device that are comfortable and sufficient for securing the device during one activity may not be comfortable or sufficient for another activity.

Furthermore, head-mountable devices, as noted above, can include a number of electronic components configured to operate together to produce an altered or virtual reality experience to the user. Users often desire light weight, compact devices that are comfortable, portable, long lasting, and easily handled. Thus, the physical configuration of these electronic components, including batteries, speakers, processors, and so forth, affects the quality of the user's experience.

Accordingly, what is needed in the art are head-mountable devices and systems providing users having a wide variety of anatomical features and who participate in a wide variety of activities with comfortable and reliable components.

### SUMMARY

In at least one example of the present disclosure, a head-mountable device can include a viewing frame and a securement arm extending from the viewing frame. The securement arm can include a first portion having a first electronic component and a second portion rotatably connected to the first portion. The second portion can include a second electronic component. The securement arm can also include an electrical connector extending through the joint and electrically connecting the first electronic component and the second electronic component.

In one example, the head-mountable device further includes a housing defining an internal volume. In one example, the join includes a notch defined by the housing, the notch including an open cut away feature. In one example, the head-mountable device can further include a biasing member disposed in the notch. In one example, the electrical connector extends between the biasing member and the housing through the joint. In one example, the electrical connector can include a planar flex. In one example, the second electrical component includes a battery. In one example, the first electronic component includes a speaker.

In at least one example of the present disclosure, a securement arm for an optical device includes a proximal portion connected to a distal portion at a joint and an electronic circuitry component extending from the proximal portion to the distal portion through the joint. In such an example, the distal portion is axially rotatable relative to the proximal portion at the joint.

In one example, the joint includes a ball-and-socket joint. In one example, a ball of the ball-and-socket joint defines an open channel through which the electronic circuitry component extends. In one example, the proximal portion includes a first housing, and the distal portion includes a second housing, and the join further includes a biasing member disposed between the first housing and the second housing. In one example, the biasing member includes an elastic ring through which the electronic circuitry component extends. In one example, the joint further includes a trim piece disposed between the biasing member and at least one of the first housing and the second housing. In one example, rotating the distal portion axially changes an angle of the distal portion relative to the proximal portion.

In at least one example of the present disclosure, an optical device includes a viewing frame, a securement arm extending from the viewing frame. The securement arm can include a proximal portion connected to the viewing frame and a distal portion rotatably connected to the proximal portion. The optical device can also include an electronic component disposed in the distal portion, an electrical circuitry component connected to the electronic component and extending through the joint, and a biasing member disposed between the proximal portion and the distal portion.

In one example, the biasing member includes a C-spring. In one example, the distal portion is rotatable about a central longitudinal axis of the securement arm. In one example, the distal portion includes a curved tip disposed at an angle relative to the proximal portion. In on example, rotating the distal portion about the central longitudinal axis changes the angle.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example of a head-mountable device worn by a user;

FIG. 2A shows a top view of an example of a head-mountable device worn by a user;

FIG. 2B shows a top view of an example of a head-mountable device worn by a user;

FIG. 3 shows a side view of an example of a head-mountable device;

FIG. 4A shows a side view of an example of a securement arm of a head-mountable device;

FIG. 4B shows a side view of an example of a securement arm of a head-mountable device;

FIG. 5 shows a perspective view of an example of a securement arm of a head-mountable device;

FIG. 6 shows a perspective view of an example of a securement arm of a head-mountable device;

FIG. 7 shows a cross-sectional view of an example of a securement arm of a head-mountable device;

FIG. 8A shows a cross-sectional view of an example of a securement arm of a head-mountable device;

FIG. 8B shows a cross-sectional view of an example of a securement arm of a head-mountable device;

FIG. 8C shows a cross-sectional view of an example of a securement arm of a head-mountable device;

FIG. 9 shows a side view of an example of a securement arm of a head-mountable device;

FIG. 10 shows a cross-sectional view of an example of a securement arm of a head-mountable device;

FIG. 11A shows a side view of a securement arm of an example of a head-mountable device;

FIG. 11B shows a top view thereof;

FIG. 12A shows a side view of an example of a securement arm of a head-mountable device, similar to the securement arm shown in FIG. 11A but with a distal portion of the securement arm rotated relative to a proximal portion;

FIG. 12B shows a top view thereof;

FIG. 13 shows a cross-sectional view of an example of a securement arm of a head-mountable device; and

FIG. 14 shows an exploded view of an example of a securement arm of a head-mountable device.

### DETAILED DESCRIPTION

Detailed reference will now be made to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to head-mountable electronic devices. In at least one example, a head-mountable device can include a viewing frame and a securement arm extending from the viewing frame. Examples of head-mountable electronic devices can include virtual reality or augmented reality devices that include an optical component. In the case of augmented reality devices, optical eyeglasses can be worn on the head of a user such that optical lenses and/or optical displays are positioned in front of the user's eyes. In another example, a virtual reality device can be worn on the head of a user such that a display screen is positioned in front of the user's eyes. The viewing frame can include a housing or other structural component supporting or housing the optical component, for example lenses or screens.

Examples of the present disclosure can include a securement arm extending from the viewing frame, which can be fixed in position relative to the viewing frame or rotatably secured thereto. An optical electronic device can include two opposing securement arms that can apply pressure to or around a user's head to maintain the viewing frame resting on the user's nose and/or cheeks. In some examples, the securement arms can rest on top of the user's ears to assist in securing the head-mountable optical device to the head of the user.

The securement arm can include multiple portions and one or more electronic components used to operate the head-mountable electronic device. These components can include any components used by the head-mountable electronic device to produce a virtual or augmented reality experience. For example, electronic components of the securement arm can include one or more speakers, processors, batteries, circuitry components including wires and circuit boards, or any other electronic components used in the head-mountable device to deliver augmented or virtual reality visuals, sounds, and other outputs. Disposing various electronic components within the securement arm reduces weight and space needed for the viewing frame and lenses and/or display screens of the device. This redistributed weight can relieve pressure of sensitive features like the user's nose and cheeks to create a more comfortable experience. This weight distribution can also be used to balance weight from the front of the device (at the viewing frame) to the back of the device (at the distal ends of the securement arms), resulting in a more secure and comfortable experience.

In examples where the securement arm includes multiple portions, a first portion can include a first electronic device and a second portion can include a second electronic device. The first portion can be connected to a second portion at a joint and the second portion can include a second electronic device. In at least one example, the first electronic device and the second electronic device can be electrically connected with an electrical connector extending through the joint. The second portion can rotate relative to the first portion so adjust the angle of the second portion relative to the first portion. The electrical connector can extend through the joint such that rotation of the second portion at the joint does not affect the electrically connectivity of the first electrical component with the second electrical component via the electrical connector.

Head-mountable electronic devices, such as head-mountable optical devices delivering virtual and augmented reality experiences, can be used in a variety of different settings and during a variety of activities. For example, a user may lie down on a sofa or a bed while watching a movie or playing a game with a head-mountable virtual reality device. That same device, or some other augmented reality device, such as electronic glasses, can be used while exercising indoors on an exercise machine. Similarly, devices like augmented reality glasses can be used while being active outdoors, either while hiking, biking, or swimming. The devices of the present disclosure include components, such as securement arms, which can be adapted to effectively secure head-mountable devices to the user during any of the various activities in which the user participates.

In addition, the head measurements and anatomical features of each user vary such that a securement arm of the same length, shape, and curvature, may not be appropriate for every user. For example, some heads are more round than others. Some heads are larger or smaller and the position of a user's nose relative to their eyes can vary. The position of a user's ears relative to their nose or forehead can vary from one user to another such that a set of securement arms that effectively secure a head-mountable device to one user may not effectively secure the same device to anther user.

In addition, manufacturing individualized arms for each unique customer can be burdensome and often economically unfeasible. The head-mountable electronic devices of the present disclosure include securement arms and components that can be altered and customized to each user and for each activity. The same user can adjust the securement arms of a device, for example, to pressure more tightly or wrap further around his or her head when using the head-mountable device for exercise or other active scenarios. The same user can readjust the securement arms for a more comfortable fit while using the head-mountable device for less active scenarios, including lying down, sitting, or walking. In addition, some head-mountable devices may be used by multiple people, including multiple people in a household or business office, with each person having a different head geometry. Securement arms for devices described herein can be customized for the same device to be comfortably and effectively used by each of the multiple individuals using the device.

In one example, the second portion can rotate relative to the first portion of the securement arm to change the angle of the two portions relative to one another. In one example, the second portion can be a distal portion and the first portion can be a proximal portion secured to the viewing frame. The second portion can rotate axially around a longitudinal axis of the second portion at the joint. In such an example, the second distal portion can be shaped such that when the second portion is rotated, the second portion changes angles or curvature relative to the first proximal portion. In this way, the overall curvature of the securement arm can be adjusted and customized to each user or for a single user participating in different activities.

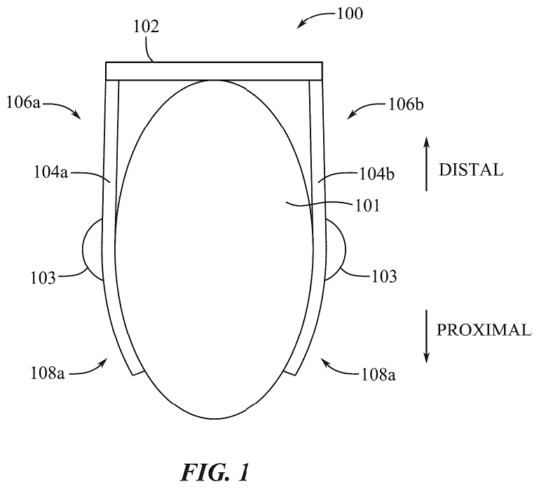

These and other embodiments are discussed below with reference to FIGS. 1-14. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a head-mountable electronic device 100 worn on the head 101 of a user. The device 100 can include a viewing frame 102 configured to secure one or more optical lenses or display screens in front of the eyes of the user. The device 100 can also include one or more securement arms 104a, 104b secured to the viewing frame 102 and extending distally toward the rear of the user's head 101. In the illustrated example, the securement arms 104a, 104b extend over the user's ears 103 and curve along with the user's head 101. The securement arms 104a, 104b can apply opposing pressures to the sides of the user's head 101, as shown, to secure the device 100 to the user's head 101. The securement arms 104a, 104b can also rest on the user's ears 103 and secure the device 100 via friction between the securement arms 104a, 104b and the head 101.

As noted, the securement arms 104a, 104b can also curve along with the curve of the user's head 101. In particular, in at least one example, the securement arms 104a, 104b can include a first proximal portion 106a, 106b and a second distal portion 108a, 108b, respectively. The distal portion 108a, 108b of each arm 104a, 104b can be curved or disposed at an angle relative to the first proximal portion 106a, 106b such that at least a portion of each arm 104a, 104b makes contact along a length of the side of the user's head. In the illustrated example of FIG. 1, at least the distal portions 108a, 108b of the arms 104a, 104b curve with the user's head 101 to make contact with the head 101. In addition, the arms 104a, 104b can extend distally and curve around a portion of the back of user's head 101, as shown, to hook around the head 101 and prevent the viewing frame 102 from being pulled forward proximally off the face/head 101 of the user.

However, as noted above, the head 101 of the user can be a unique shape and size with a unique position of each ear 103 such that the curvature of the arms 104a, 104b of the device 100 shown in FIG. 1 may not be a match for the curvature and anatomy of the head of a different user. In general, the hooked arms 104a, 104b around the sides and rear of the head 101 in addition to the increased contact area and/or length between the arms 104a, 104b and head 101 improve the resistance of the arms 104a, 104b to forces pulling the viewing frame 102 proximally off the user's head 101. Such forces can arise from jostling and bumping during normal use of the device 100 or more detrimentally during falls or contact with other objects during use. Thus, the curvature of the securement arms 104a, 104b, and more particularly the curvature of the distal portions 108a, 108b of the arms 104a, 104b, which can be effective for retaining the device 100 on the head 101 shown in FIG. 1, may not be effective for a user with a head of a different size or shape.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

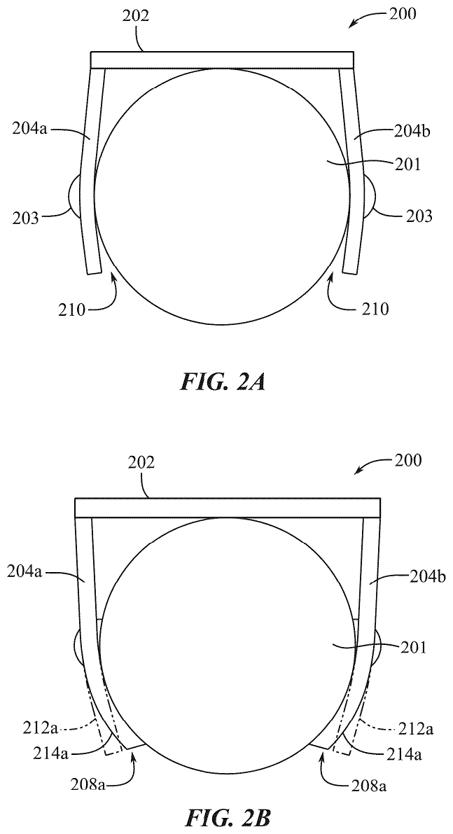

A user having a head 201 of a different size and shape as that of the head 101 shown in FIG. 1 is shown in FIG. 2. The same or similar head-mountable electronic device 200 can include a viewing frame 202 secured, at least in part, to the user's head 201 via one or more securement arms 204a, 204b. As show, the securement arms 204a, 204b can extend distally along opposing sides of the head 201. In the example shown, the arms 204a, 204b can extend over the user's ears 203 and toward the rear of the user's head 201. However, due to the shape of the user's head 201, the curvature of the arms 204a, 204b results in a gap 210 between the head 201 and the arms 204a, 204b.

In at least one example, the arms 204a, 204b can be configured to be adjusted to eliminate the gap 210 and increase the contact area and/or length between the arms 204a, 204b and the head 201. The adjustable arms 204a, 204b can also be reconfigured to hook further around the user's head 201 to more effectively secure the device 200 to the head 201. As shown in FIG. 2B, the arms 204a, 204b include a distal portion 208a, 208b, respectively, that can be adjusted to curve with the profile and anatomical features of the user's head 201 as shown. The first position 212a, 212b of the distal portions 208a, 208b of the arms 204a, 204b, which results in the gap 210 shown in FIG. 2A, is shown in dotted lines. An adjusted second position 214a, 214b of arms 204a, 204b are shown conforming to a curvature of the user's head 201. The distal portion 208a, 208b of each arm 204a, 204b can be adjusted by the user to accommodate the user's head 201 as shown to eliminate the gap 210 and more securely fasten or hold the device 200 onto the user's head 201.

Any of the features, components, and/or parts, including the arrangements and configurations thereof shown in FIGS. 2A and 2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A and 2B.

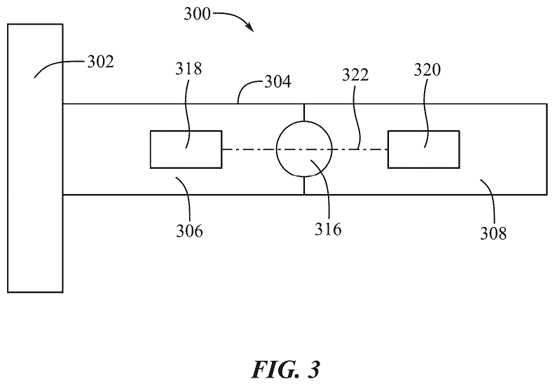

FIG. 3 shows a side view of an example of a head-mountable device 300, including a viewing frame 302, and a securement arm 304 extending from the viewing frame 302. As noted above, in some examples, the arm 304 can be hingedly or rotatably attached to the viewing frame 302. In some examples, the arm 304 can be fixedly or unmovably attached or secured to the viewing frame. In at least one example, the arm 304 can include a first portion 306 including a first electronic component 318 and a second portion 308 rotatably connected to the first portion 306 at a joint 316. The second portion 308 can include a second electronic component 320. Additionally, at least one example can include an electronic circuitry component 322 extending through the joint 316 and electrically connecting the first electronic component 318 and the second electronic component 320.

As used herein, the term “joint” can refer to a structure enabling one portion of the arm 304 to rotate or move relative to another portion, for example the second portion 308 relative to the first portion 306. In some examples, the first and second portions 306, 308 can be separate pieces such that the joint 316 includes one or more structures rotatably connecting both separate pieces. In some examples, the arm 304 can include first and second portions 306, 308 that are integrally formed as a unitary piece such that the joint 316 is defined by a portion or section of the unitary piece that allows the second portion 308 of the arm 304 on one side of the joint 316 to rotate relative to the first portion 306 on the other side of the joint 316. For example, the first and second portions 306, 308 can be formed as a single, unitary piece and the joint 316 can include a reduced cross-section or flexible portion of the unitary arm 304 that allows the second portion 308 to rotate relative to the first portion 306 by bending the unitary arm 304 at the joint 316. More details regarding various examples of joints and joint structures are given below with reference to other figures.

Referring still to FIG. 3, the arm 304 can include the distal portion 308 and the proximal portion 306 beginning proximally where the proximal portion 306 connects (either rigidly or rotatably) to the viewing frame 302 and extending along a major length distally to a distal termination of the distal portion 308. In at least one example, a major length of the distal portion 308 is about 75% or less than a total major length of the arm 304. In at least one example, the distal portion is about 60% or less or about 50% or less of the total length of the arm 304. In some examples, the distal portion 308 of the arm 304 can be about 40% or less, about 30% or less, about 20% or less, about 10% or less, or about 5% or less than a total length of the arm 304. Correspondingly, the proximal portion can be at least about 25% of the total length of the arm 304 in one example, or at least about 40% of the total length of the arm 304 in another example. In one or more other examples, the proximal portion 306 can be at least about 50%, at least about 60%, at least about 70%, at least about 80%, at least about 90%, or at least about 95% of the total length of the arm 304.

The first and second electronic components 318, 320 can include any number of electronic components configured to operate and produce a virtual or augmented reality experience to the user through the device 300. For example, the first electronic component 318 can include a speaker, processor, or memory component and the second electronic component 320 can include a battery or any other component including those described with reference to the first electronic component 318. In examples where the second electronic component 320 includes a battery, the battery can be connected to the first electronic component 318 via the electronic circuitry component 322 to deliver power to the first electronic component 318.

In at least one example, the electronic circuitry component 322 can include one or more electrically conductive wires, flexes, resistors, circuit boards, or any other electronic circuitry components connecting the first electronic component 318 and the second electronic component 320. In at least one example, the arm 304 can include a housing defining an external surface and an interior volume. The first electronic component 318, the second electronic component 320, and/or the electronic circuitry component can be disposed within the internal volume such that the components are hidden from view. Alternatively, one or more of the components shown 318, 320, and 322 can be disposed on the housing. The electronic circuitry component 322 can extend through the joint 316 such that the functionality of the joint 316 and the electronic circuitry component 322 is not hindered. More details regarding examples of the joint 316 and electronic circuitry component 322 are given hereafter with reference to other figures.

In at least one example, the device 300 can include an optical device and the first portion 306 of the arm 304 can be referred to as a proximal portion. In such an example, the second portion 308 of the arm 304 can be referred to as a distal portion. The terms “proximal” and “distal” can be used to reference the position of various components of devices described herein relative to the viewing frame 302 of the device 300. The orientation of the “proximal” and “distal” directions relative to devices described herein is shown in FIG. 1.

Referring back to FIG. 3, the electronic circuitry component 322 can extend from the proximal portion 306 to the distal portion 308 through the joint 318. In such an example, the electronic circuitry component 322 remains protected within an internal volume of the arm 304 within the proximal portion 306, distal portion 308, and the joint 316. In at least one example, the distal portion 308 is rotatable relative to the proximal portion 306 at the joint 316 such that an angle between the proximal portion 306 and the distal portion 308 is variable. In this way, in at least one example, a user can rotate the distal portion 308 relative to the proximal portion 306 to alter an overall angle of the arm 304, or at least the angle of the distal portion 308, to accommodate the specific angle and curvature of the side of the user's head. Thus, the user can rotate the distal portion 308 at the joint 316 to customize the arm 304 to more effectively and comfortably secure the device 300 to his or her head.

In at least one example, the joint 316 can include a biasing member disposed between the distal portion 308 and the proximal portion 306. The biasing member can include any number of mechanisms, including springs and/or elastic materials, so that once the angle and relative position between the proximal portion 306 and distal portion 308 of the arm 304 is set by the user, the position of the distal portion 308 can still be elastically manipulated relative to the proximal portion 306 without permanently affecting the angle and position of the arm 304 and portions 306, 308 thereof. For example, once the relative position and angle of the distal portion 308 is set relative to the proximal portion 306 via the joint 316, the user can elastically expand the distance between opposing arms 304 of the device 300 while donning and doffing the device before, after, and during use, without plastically changing the relative position and angle between the proximal and distal portions 306, 308.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

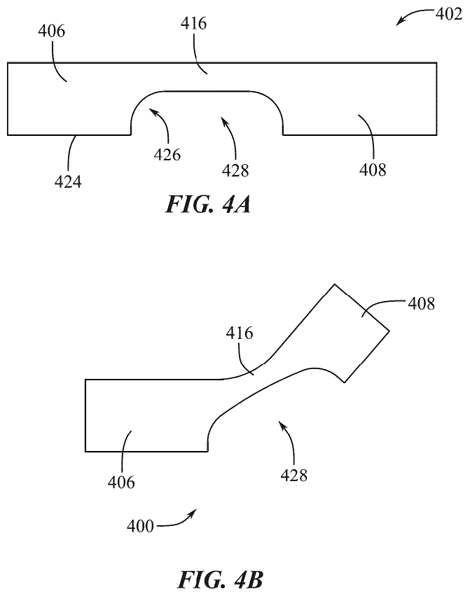

FIG. 4A shows a side view of another example of a securement arm 404, including a first proximal portion 406 and a second distal portion 408 rotatably connected to the proximal portion 406 at a joint 416. In the illustrated example, the joint 416 includes a notch 428 forming a reduced cross-sectional area of material at the joint 416. The reduced material of the arm 404 at the joint 416 forms a flexible portion of the arm 404 that can be bent to change the relative position and angle of the first and second portion 406, 408 of the arm 404. In the illustrated example, the notch 428 includes a cutaway feature removing material from the arm 404.

In at least one example, the notch 428 cuts away at a housing 424 of the arm 404 such that the notch 428 extends into, exposes, and/or opens into an internal volume 426 of the arm 404 defined by the housing 424. In some examples, the cut away feature of the notch 428 does note open into and exposed internal volume 426. Rather, in some examples, the housing 424 forms the notch 428 such that a cross-sectional area or perimeter of the arm 404 at the joint 416 is reduced compared to the cross-sectional area or perimeter of the distal portion 408 and/or the proximal portion 406 of the arm 404. In this way, the joint 416 forms a portion of the arm 404 that can more easily be bent or deformed by the user to manipulate and change the relative angle and position of the proximal portion 406 and the distal portion 408.

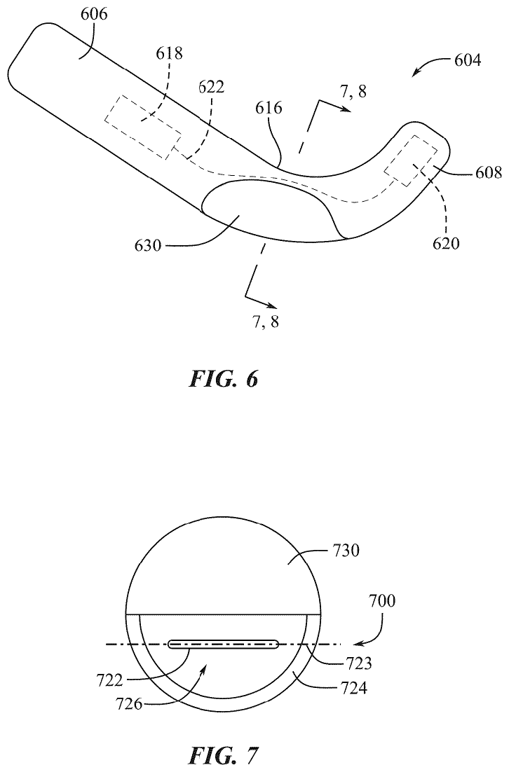

The reduced cross-sectional area or perimeter of the arm 404 at the joint 416 can also reduce the strain of the material of the arm 404 and thus minimizes the risk of fracture or cosmetic failure. The minimum cross-sectional area or perimeter of the arm 404 at the joint 416 can be as small as possible while accommodating the electrical or other functional components that may be disposed within the arm 404 at the joint 416 in one or more examples. Such examples are shown and described below with reference to other figures, including FIGS. 6-8C.

FIG. 4B shows a side view of the arm 404 shown in FIG. 4A but with the distal portion 408 disposed at an angle relative to the proximal portion 406 via the joint 416. As noted, the joint 416 can be bent to reorient the distal portion 408 relative to the proximal portion 406 as shown. The notch 428 can be altered to accommodate the bent joint 416.

Any of the features, components, and/or parts, including the arrangements and configurations thereof shown in FIGS. 4A and 4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A and 4B.

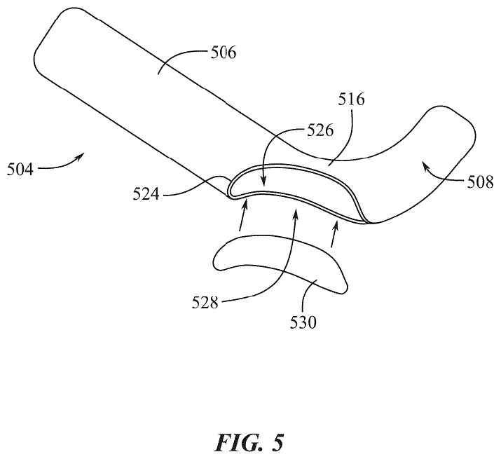

FIG. 5 illustrates a perspective view of another example of a securement arm 504, including a proximal portion 506 and a distal portion 508 rotatably secured to the proximal portion 506 at a hinge 516. The hinge 516 can include a cut away feature such as a notch 528 to reduce the cross-sectional area or perimeter of the material at the joint 516. The arm 504 can include a housing 524 defining an external surface and an internal volume 526 of the arm 504. In at least one example, the arm 504 can also be overmolded with a material at least in part defining a bias spring rate of the arm 504, including the spring rate at the joint 516 of the arm 504. In one example, the arm 504 can be overmolded with a material including a composite material, steel, bulk metallic glass, or the like, defining the biasing spring rate of the arm 504 at the joint 516.

Additionally, or alternatively, in at least one example, the arm 504, or the joint 516 of the arm 504, can include a biasing member 530 disposed at or near the joint 516 or as a part of the joint 516. The biasing member 530 can include an elastic material, including rubber, silicone, elastic polymers, or some combination of these or other elastic materials, disposed in the notch 528. The illustrated example of FIG. 5 shows an exploded view of the arm 504 and the biasing member 530 with arrows indicating that the biasing member 530 can be disposed in the notch 528 and in contact with the housing 524. In at least one example, the biasing member 530 can be formed of silicone. In other examples, the biasing member 530 can be formed of one or more other elastic materials, including elastic polymer materials or various foam materials.

FIG. 6 illustrates a perspective view of another example of a securement arm 604, including a proximal portion 606 and a distal portion 608 rotatably secured to the proximal portion 606 at a hinge 616. The hinge 616 can include a cut away feature such as a notch 628 to reduce the cross-sectional area or perimeter of the material at the joint 616. In addition, the arm 604, or the joint 616 of the arm 604, can include a biasing member 630 disposed at or near the joint 616 or as a part of the joint 616. The biasing member 630 can include an elastic material, including rubber, silicone, elastic polymers, or some combination of these or other elastic materials, disposed in the notch 628. The illustrated example of FIG. 5 shows the biasing member 630 assembled with the arm 604 at or near the joint 616.

The distal portion 608 is disposed at an angle relative to the proximal portion 606 via the bent joint 616. The example of the arm 604 shown in FIG. 6 can also include a first electronic component 618 disposed within the proximal portion 606 and a second electronic component disposed in the distal portion 608. In addition, an electrical connector, such as the electronic circuitry component 622 shown in FIG. 6, can extend from the first electronic component 618 to the second electronic component 620 through the joint 616. In particular, in at least one example, the electronic circuitry component can extend between the biasing member 630 and the housing through the joint 616.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

FIG. 7 shows a cross-sectional view of an example of a securement arm 704, similar to that shown in FIG. 6 with the location of the cross-sectional plane indicated in FIG. 6 through the joint 616. The arm 704 can include a biasing member 730 disposed in a notch and in contact with a housing 724 of the arm 704. The electronic circuitry component 722, which can also be referred to as an electrical connector, can be disposed between the biasing member 730 and the housing 724 as the electrical circuitry component 722 extends through the joint. In at least one example, the electronic circuitry component 722 can include a flat, planar electrical flex, as shown in FIG. 7.

In at least one example, the electronic circuitry component 722 is disposed within the internal volume 726 defined by the housing 724 such that at the joint, the electronic circuitry component 722 is not in contact with the housing 724. Rather, in the example shown in FIG. 7, the electronic circuitry component 722 is suspended in the internal volume 726. In at least one example, the electronic circuitry component 722 can be disposed at a neutral axis 723 of the joint. In this way, the electronic circuitry component 722 can avoid flex stress or other damage when the user bends the arm 704 at the joint (where the cross-sectional view of FIG. 7 is shown).

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

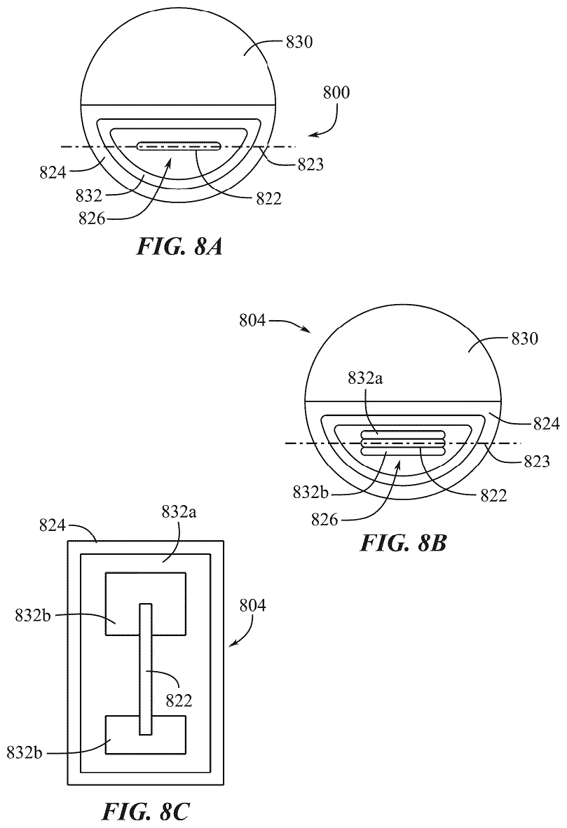

FIG. 8A shows a cross-sectional view of an example of a securement arm 804, similar to that shown in FIG. 6 with the location of the cross-sectional plane indicated in FIG. 6 through the joint 616. The arm 804 can include a biasing member 830 disposed in a notch and in contact with a housing 824 of the arm 804. The electronic circuitry component 822, which can also be referred to as an electrical connector, can be disposed between the biasing member 830 and the housing 824 as the electrical circuitry component 822 extends through the joint. In at least one example, the electronic circuitry component 822 can include a flat, planar electrical flex, as shown in FIG. 8A.

In addition, the example of FIG. 8A illustrates the housing 824 extending between the biasing member 830 and the electronic circuitry component 822. In this way, the internal volume is closed within the arm 804 at the joint and the notch does not form an open feature into the internal volume of the arm 804. In addition, the arm 804 shown in FIG. 8A can include an additional protective layer 832 disposed against an internal surface of the housing 824 and surrounding the electronic circuitry component 822. The protective layer 832 can extend at least partially through the joint of the arm 804 to protect the electronic circuitry component 822 from damage as the user bends the arm 804 at the joint through which the electronic circuitry component 822 extends.

In at least one example, the electronic circuitry component 822 is disposed within the internal volume 826 defined by the housing 824 and/or the protective layer 832 such that at the joint, the electronic circuitry component 822 is not in contact with the housing 824. Rather, in the example shown in FIG. 8A, the electronic circuitry component 822 is suspended in the internal volume 826. In at least one example, the electronic circuitry component 822 can be disposed at a neutral axis 823 of the joint. In this way, the electronic circuitry component 822 can avoid flex stress or damage when the user bends the arm 804 at the joint (where the cross-sectional view of FIG. 8A is shown).

The protective layer 832 can be formed of various materials, including composite materials, steels, and bulk metallic glass, which can be utilized based on material spring rates, strength, modulus, and other properties. In one example, the material of the protective layer 832a can be formed of one or more materials having spring rates high enough to provide stability on the user's head, but low enough not to feel too stiff and to be able to conform the arm 804 to the user's head. In addition, the material of the protective layer 832a can be high strength and low modulus materials. In one example, polymers can be used to form the protective layer 832a in order to withstand high amounts of strain.

Any of the features, components, and/or parts, including the arrangements and configurations thereof shown in FIG. 8A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8A.

FIG. 8B shows a cross-sectional view of an example of a securement arm 804, similar to that shown in FIG. 6 with the location of the cross-sectional plane indicated in FIG. 6 through the joint 616. The arm 804 can include a biasing member 830 disposed in a notch and in contact with a housing 824 of the arm 804. The electronic circuitry component 822, which can also be referred to as an electrical connector, can be disposed between the biasing member 830 and the housing 824 as the electrical circuitry component 822 extends through the joint. In at least one example, the electronic circuitry component 822 can include a flat, planar electrical flex, as shown in FIG. 8B.

In addition, the example of FIG. 8B illustrates the housing 824 extending between the biasing member 830 and the electronic circuitry component 822. In this way, the internal volume is closed within the arm 804 at the joint and the notch does not form an open feature into the internal volume of the arm 804. In addition, the arm 804 shown in FIG. 8A can include protective layers 832a and 832b disposed against opposing sides of the electronic circuitry component 822. The protective layers 832a and 832b can extend at least partially through the joint of the arm 804 to protect the electronic circuitry component 822 from damage as the user bends the arm 804 at the joint through which the electronic circuitry component 822 extends.

In at least one example, the protective layers 832a and 832b can include a singular component extending peripherally around the edges of the electronic circuitry component 822 such that the protective layer 832 (a and b) completely or partially surrounds the electronic circuitry component 822. In some other examples, the protective layer 822 can be disposed within the internal volume 826 between the housing 824 and the electronic circuitry component 822 without contacting either the housing 824 or the electronic circuitry component 822.

In any case, including the example of the protective layer 832 shown in FIG. 8A, the protective layer 832a and 832b can be formed of various materials, including composite materials, steels, and bulk metallic glass, which can be utilized based on material spring rates, strength, modulus, and other properties. In one example, the material of the protective layers 832a and 832b can be formed of one or more materials having spring rates high enough to provide stability on the user's head, but low enough not to feel too stiff and to be able to conform the arm 804 to the user's head. In addition, the material of the protective layers 832a and 832b can be high strength and low modulus materials. In one example, polymers can be used to form the protective layers 832a and 832b in order to withstand high amounts of strain.

In at least one example, the electronic circuitry component 822 is disposed within the internal volume 826 defined by the housing 824 and/or the protective layer 832 such that at the joint, the electronic circuitry component 822 is not in contact with the housing 824. Rather, in the example shown in FIG. 8B, the electronic circuitry component 822 is suspended in the internal volume 826. In at least one example, the electronic circuitry component 822 can be disposed at a neutral axis 823 of the joint. In this way, the electronic circuitry component 822 can avoid flex damage when the user bends the arm 804 at the joint (where the cross-sectional view of FIG. 8B is shown).

FIG. 8C shows a cross-sectional view of another example of the arm 804, including protective layers 832a, 832b, the electronic circuitry component 822, and the housing 824. In the example illustrated in FIG. 8C, the arm 804 can include a three-shot molding configuration around the electronic circuitry component 822, including a first shot forming the protective layer 832b, a second shot forming the protective layer 832a, and a third shot forming the housing 824. In at least one example, the first shot protective layer 832b can be formed as two separate portions, each engaging the electronic circuitry component 822 at opposing edges thereof.

In at least one example, the first shot protective layer 832a can include a more rigid or harder material than that of the second shot protective layer 832a and/or the third shot housing 824. For example, the first shot protective layer 832b can include a plastic, while the second shot protective layer 832a includes silicone or another polymer that is less rigid or strong relative to the first shot protective layer 832b. In the illustrated example, the first shot protective layer 832b can contact the electronic circuitry component 822 at opposing edges (upper and lower edges as oriented in FIG. 8C), while the second shot protective layer 832a contacts the electronic circuitry component 822 between the two portions of the first shot protective layer 832b.

In at least one example, the first shot protective layer 832a can be more rigid or harder than the third shot housing 824. In one example, the housing 824 can include silicone. In at least one example, the silicone material of the housing 824 can be different from the silicone material of the second shot protective layer 832a. In one example, the housing 824 can define an exterior surface of the arm 804 and can include a more aesthetically pleasing silicone material.

In at least one example, the arm 804 shown in FIG. 8C can include only the housing 824 and the protective layer 832a such that the arm 804 is molded around the electronic circuitry component 822 in a two-shot molding process with the protective layer 832a as the first shot and the housing 824 as the second shot. In such an example, the protective layer 832a can contact the electronic circuitry component 822 directly and/or can surround and contact the electronic circuitry component 822. In another example, the arm 804 can include only the first shot protective layer 832b and the second shot protective layer 832a without the housing 824 such that the second shot protective layer 832a defines an exterior surface of the arm 804.

Any of the features, components, and/or parts, including the arrangements and configurations thereof shown in FIG. 8B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8B.

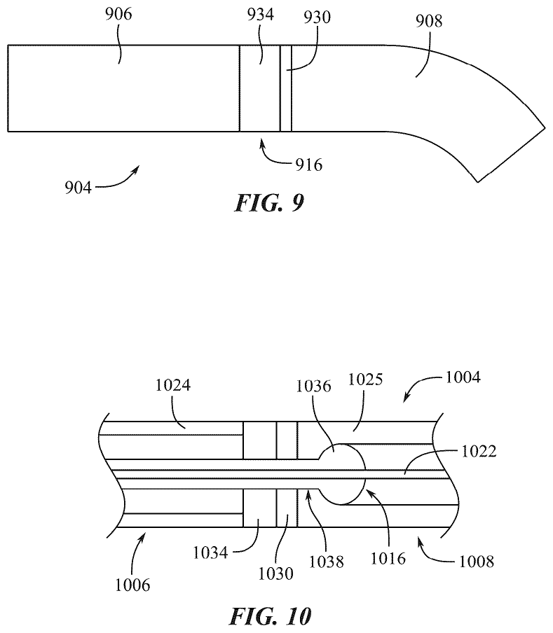

FIG. 9 shows a side view of another example of a securement arm 904 of a head-mountable electronic device, for example a head-mountable optical device. The securement arm 904 can include a proximal portion 906 and a distal portion 908 rotatably secured to the proximal portion 906 at a joint 916. The joint can include a biasing member 930 disposed between the proximal portion 906 and the distal portion 908. In at least one example, the joint 916 can also include a trim piece 934 spanning a space between the biasing member 930 and either the proximal portion 906 or the distal portion 908 or a space between the proximal portion 906 and the distal portion 908.

In the illustrated example of FIG. 9, the biasing member 930 is adjacent the distal portion and the trim piece 934 is positioned adjacent the proximal portion 906. However, in at least one example, the biasing member 930 can be disposed adjacent the proximal portion 906 and the trim piece 934 can be disposed adjacent the distal portion 908. In at least one example, the proximal portion 906 of the arm 904 can be straight and the distal portion 908 can be curved, as shown.

In at least one example, the curved distal portion 908 can be configured to curve around the top of a user's ear when the arm 904 secures a head-mountable device to the user's head. In at least one example, the curved distal portion 908 can be configured to curve distally around a rear portion of the user's head. The shape and angle or radius of curvature of the distal portion 908 can vary in one or more examples. In addition, in at least one example, the distal portion 908 can be rotatably connected to the proximal portion 906 such that rotating the distal portion 908 changes the curvature of the distal portion 908 around the back of the user's head and over and down the back of the user's ear.

For example, the distal portion can be rotated about a central longitudinal axis of the distal portion 908, which is aligned with a central longitudinal axis of the proximal portion 906 at the joint 916 to form a combined central longitudinal axis of the arm 904. In such an example, rotating the distal portion 908 about the central longitudinal axis of the arm at the joint 916 can orient the distal end of the distal portion 908 of the arm 904 such that the curvature of the distal portion 908 curves more or less around a rear portion of the user's head or, alternatively, more or less over and downward distally to the user's ear.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

FIG. 10 shows a cross-sectional view of a joint 1016 of a securement arm 1004, which can be similar to the securement arm 904 shown in FIG. 9. In the illustrated example of FIG. 10, the arm 1004 includes a proximal portion 1006 and a distal portion 1008 rotatably connected to the proximal portion 1006 at the joint 1016. The space between the housing 1024 of the proximal portion 1006 and the housing 10025 of the distal portion 108 can be filled by the trim piece 1034 and the biasing member 1030 disposed between the proximal portion 100 and the distal portion 1008. In at least one example, the biasing member 1030 includes a ring of elastic material.

In at least one example, the joint 1016 can include a ball-and-socket joint 1016, including a ball 1036 extending from a join member of the proximal portion 1006 and disposed in a socket 1038 of the distal portion 1008. The ball-and-socket joint 1016 enables the rotation of the distal portion 1008 in multiple degrees of freedom, including a rotation of the distal portion 1008 axially about a central longitudinal axis of the distal portion 1008 at the joint 1016, as discussed above. The ball-and-socket joint 1016 shown in FIG. 10 also allows for the lateral, vertical, or other rotations of the distal portion 1008 relative to the proximal portion 1006.

In at least one example, the ball 1046 defines an open channel through which the electronic circuitry component 1022 can extend from the proximal portion 1006 to the distal portion 1008 as shown. In at least one example, the electronic circuitry component 1022 can electrically connect a first electronic component disposed in or on the proximal portion 1006 with a second electronic component disposed in or on the distal portion 1008. In at least one example, the electronic circuitry component 1022 extending through the ball-and-socket joint 1016 shown in FIG. 10, or any other joint shown in other figures and described herein, can include one or more electrical wires, including a cord, cable, or bundle of wires, including a cable bundle. The biasing member 1030 can include an elastic ring disposed around the ball 1036 and socket 1038 of the ball-and-socket joint 1016 and around the electronic circuitry component 1022.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

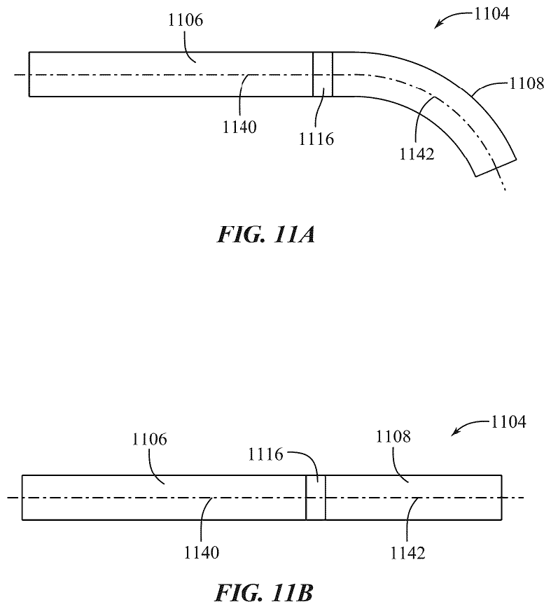

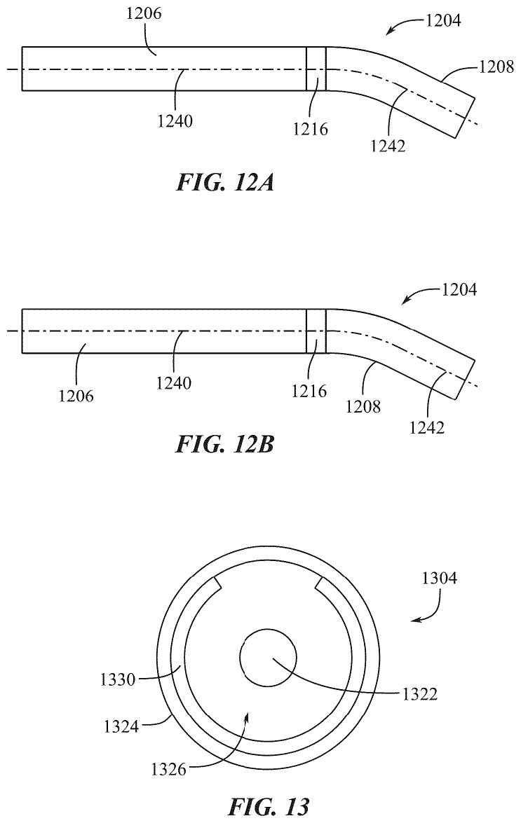

FIG. 11A shows a side view of a securement arm 1104 of an example of a head-mountable device and FIG. 11B shows a top view thereof. Similarly, FIG. 12A shows a side view of an example of a securement arm 1204 of a head-mountable device, similar to the securement arm 1104 shown in FIG. 11A but with a distal portion 1208 of the arm 1204 rotated relative to a proximal portion 1206, and FIG. 12B shows a top view thereof. In FIGS. 11A and 11B, the arm 1104 includes a straight proximal portion 1106 and a curved distal portion 1108 rotatably connected to the proximal portion 1106 at a joint 1116. A central longitudinal axis 1140 of the proximal portion 1106 is aligned with a central longitudinal axis 1142 of the distal portion 1108 at the joint 1116.

In the side view of FIG. 11A, the curved distal portion extends distally backward and downward from the proximal portion 1106. In this way, the curved distal portion 1108 can curve over the user's ear above which and/or on which the arm 1104 extends and/or rests, respectively. From the top view of FIG. 11B, the distal portion 1108 extend distally backward but does not curve one way or the other, for example around a rear portion of the user's head.

In the side and top views of the arm 1204 of FIGS. 12A and 12B, respectively, where the distal portion 1208 has been rotated about the central longitudinal axis 1242 of the distal portion 1208, which is aligned with the central longitudinal axis 1240 of the proximal portion 1206 at the joint 1216, the curved distal portion 1208 is configured to curve around the rear portion of a user's head and also curve distally backward and downward over the user's ear. In some scenarios, the user can rotate the distal portion 1208 enough to curve laterally around the rear portion of a user's head without curving downward distally to the user's ear. In examples of securement arms disclosed herein, the user can rotate the or adjust the distal portion of the securement arm to customize the angle or degree to which the securement arm extends around the user's head and over the user's ear to adapt to the user's head shape, size, and activity in which the user is participating.

For example, rotating the distal portion of a securement arm described herein can result in a great pinch force or pressure against opposing sides of the user's head between opposing securement arms as the distal portion rotates further around the rear portion of the head. This may be appropriate for active scenarios, including exercising, but the pressure from the securement arms may be uncomfortable for long periods of time during relaxed activities requiring less retention force from the securement arms. Also, as noted above, the same changes can be made by rotating the distal portion of the securement arm to accommodate different users having different head shapes, sizes, and anatomical features and measurements.

Any of the features, components, and/or parts, including the arrangements and configurations thereof shown in FIGS. 11A-12B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11A-12B.

FIG. 13 shows a cross-sectional view of an example of a securement arm 1304, with the cross-sectional plane located at a joint of the arm 1304. In at least one example, the arm 1304 can include biasing member 1330 disposed within a housing 1324 of the device 1304. In at least one example, the biasing member 1330 can be disposed against an inner surface of the housing 1324 and an electronic circuitry component 1322 can pass through an internal volume defined by the housing 1324. In at least one example, the electronic circuitry component 1322 can extend through the biasing member 1330 such that the biasing member at least partially surrounds the electronic circuitry component 1322 where the electronic circuitry component 1322 passes through the joint 1316. In at least one example, the biasing member 1330 can include a C-spring, as shown in FIG. 13.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 13.

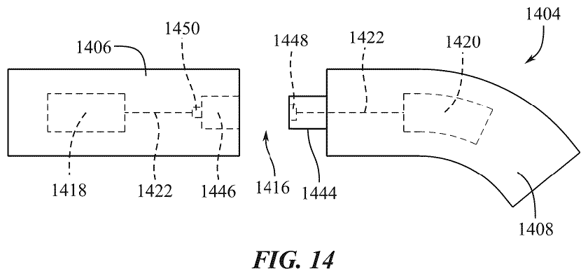

FIG. 14 shows an exploded side view of another example of a securement arm 1404 of a head-mountable electronic device. The arm 1404 shown in FIG. 14 can include a proximal portion 1406 and a distal portion 1408 rotatably and removably secured to the proximal portion 1406 at a joint 1416. The proximal portion 1406 can include a housing defining a female receiving cavity 1446 into which a male protrusion 1444 defined by the distal portion 1408 can be inserted. In one or more other examples, the distal portion 1408 can define the female receiving cavity and the proximal portion 1406 can define the male protrusion. In any case, the distal portion 1408 and the proximal portion 1416 can be fit together via a friction fit between the housing defining the female receiving cavity 1446 and the male protrusion 1444. One or more other examples can include other securement mechanisms between the distal portion 1408 and the proximal portion 1406, including mechanical latches, snaps, magnets, and so forth.

In at least one example, a first electronic component 1418 can be disposed in or otherwise with the proximal portion 1406 of the arm 1404 and a second electronic component 1420 can be disposed in or otherwise with the distal portion 1406. An electronic circuitry component 1422 can extend from the first electronic component 1418 to an electrical connector 1450 at the female receiving cavity 1446 and from the second electronic component 1420 to an electrical connector 1448 at the male protrusion 1444. When assembled together, the electrical connectors 1444 and 1446 complete a circuit between the first and second electronic components 1418, 1420 such that the electronic circuitry component 1422 connects the first electronic component 1418 with the second electronic component 1420.

In at least one example, the joint 1416 enables the user to rotate the distal portion 1408 relative to the proximal portion 1406 as discussed above. Additionally, the user can detach or disconnect the distal portion 1408 from the proximal portion 1406 to swap out and reattach a new distal portion 1408. In some examples described herein, the second electronic component 1420 of the distal portion 1408 can include a battery. The user can thus swap out the distal portion 1408 of the arm 1404 when the battery runs low with another distal portion 1408 that includes a fully charged battery. In this way, the effective battery life of the device of which the arm 1404 shown in FIG. 14 is a part can be extended for an improved user experience.

Any of the features, components, and/or parts, including the arrangements and configurations thereof shown in FIG. 14 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 14.

The present systems and methods can be used to interact with any number of environments. A physical environment or world, including physical features, object or surfaces, can be interacted with without using an electronic device. For instance, a physical environment may correspond to a physical city having physical buildings, roads, and vehicles. People may directly sense or interact with a physical environment through various senses, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

The foregoing description used specific nomenclature to provide a thorough understanding of the described embodiments. However, it will be apparent to one skilled in the art that the specific details are not required in order to practice the described embodiments. Thus, the foregoing descriptions of the specific embodiments described herein are only presented for purposes of illustration and description. They are not intended to be exhaustive or to limit the embodiments to the precise forms disclosed. It will be apparent to one of ordinary skill in the art that many modifications and variations are possible in view of the above teachings.

Various embodiments described herein can be improved on via the use of personal information data, gathered pursuant to authorized and well established secure privacy policies and practices that are appropriate for the type of data collected. However, the disclosed technology is not rendered inoperable in the absence of such personal information data.

It will be understood that the details of the present systems and methods above can be combined in various combinations and with alternative components. The scope of the present systems and methods will be further understood by the following claims.

What is claimed is:

1. A head-mountable electronic device, comprising:
a viewing frame;
a securement arm extending from the viewing frame, the securement arm comprising:
a first portion including a first electronic component;
a second portion rotatably connected to the first portion at a joint, the second portion including a second electronic component; and
an electrical connecter extending through the joint and electrically connecting the first electronic component and the second electronic component.

2. The head-mountable electronic device of claim 1, further comprising a housing defining an internal volume.

3. The head-mountable electronic device of claim 2, wherein the joint comprises a notch defined by the housing, the notch including a cut away feature.

4. The head-mountable electronic device of claim 3, further comprising a biasing member disposed in the notch.

5. The head-mountable electronic device of claim 4, wherein the electrical connector extends between the biasing member and the housing through the joint.

6. The head-mountable electronic device of claim 5, wherein the electrical connector comprises a planar flex.

7. The head-mountable electronic device of claim 1, wherein the second electrical component comprises a battery.

8. The head-mountable electronic device of claim 7, wherein the first electronic component comprises a speaker.

9. A securement arm for an optical device, comprising:
a proximal portion connected to a distal portion at a joint; and
an electronic circuitry component extending from the proximal portion to the distal portion through the joint;
wherein the distal portion is rotatable relative to the proximal portion at the joint.

10. The securement arm of claim 9, wherein the joint comprises a ball-and-socket joint.

11. The securement arm of claim 10, wherein a ball of the ball-and-socket joint defines an open channel through which the electronic circuitry component extends.

12. The securement arm of claim 9, wherein:
the proximal portion includes a first housing;
the distal portion includes a second housing; and
the joint further comprises a biasing member disposed between the first housing and the second housing.

13. The securement arm of claim 12, wherein:
the biasing member comprises an elastic ring; and
the electronic circuitry component extends through the elastic ring.

14. The securement arm of claim 12, further comprising a trim piece disposed between the biasing member and at least one of the first housing and the second housing.

15. The securement arm of claim 14, wherein axially rotating the distal portion changes an angle of the distal portion relative to the proximal portion.

16. An optical device, comprising:
a viewing frame;
a securement arm extending from the viewing frame, the securement arm including a proximal portion connected to the viewing frame and a distal portion rotatably connected to the proximal portion;
a first electronic component disposed in the distal portion;
a second electronic component connected to the first electronic component through the joint; and
a biasing member disposed between the proximal portion and the distal portion.

17. The optical device of claim 16, wherein the biasing member comprises a C-spring.

18. The optical device of claim 16, wherein the distal portion is rotatable about a central longitudinal axis of the securement arm.

19. The optical device of claim 18, wherein the distal portion includes a curved tip disposed at an angle relative to the proximal portion.

20. The optical device of claim 19, wherein rotating the distal portion about the central longitudinal axis changes the angle.
